(19) United States
(12) Patent Application Publication
(10) Pub. No.: US 2012/0044941 A1
(43) Pub. Date: Feb. 23, 2012

(54) DATA TRANSMISSION SYSTEM, DATA TRANSMISSION METHOD, AND DATA TRANSMISSION DEVICE

(75) Inventor: Eiji Nakayama, Daito-shi (JP)

(73) Assignee: KYOCERA CORPORATION, Kyoto-shi, Kyoto (JP)

(21) Appl. No.: 13/264,245

(22) PCT Filed: Apr. 5, 2010
(86) PCT No.: PCT/JP2010/056184

§ 371 Date: Oct. 13, 2011

(30) Foreign Application Priority Data
Apr. 21, 2009 (JP) 2009-103320

(51) Int. Cl. H04L 12/56

(52) U.S. Cl. 370/400

(57) ABSTRACT

A source device includes a transmission unit selecting at least one destination device among a plurality of devices for transmitting data to the selected at least one destination device through a multiport switch and serial buses. The transmission unit includes a transmission ratio determination unit determining, when a plurality of destination devices are selected, a ratio of data transmitted among the selected plurality of destination devices within 1 cycle based on a reception rate of the selected plurality of destination devices. A destination device includes a reception unit receiving data from a source device through the multiport switch and serial buses.

### TECHNICAL FIELD

The present invention relates to a data transmission system, a data transmission method, and a data transmission device. Particularly, the present invention relates to a data transmission system having a plurality of devices connected to a switch via a serial bus, a data transmission method, and a data transmission device.

### BACKGROUND ART

In recent years, the amount of communication data is increasing drastically at wireless base stations. In accordance with such increase, the amount of signal processing at devices such as a CPU (Central Processing Unit), DSP (Digital Signal Processor), FPGA (Field Programmable Gate Array) and the like in a substrate for executing the process at wireless base stations is increasing. As a result, the communication rate between these devices has become higher.

Serial RapidIO (registered trademark) is a specification to connect such various types of devices in the substrate to a multiport switch via a serial bus to allow high speed communication as fast as 10 Gbps between the devices (for example, refer to RapidIO™ Interconnect Specification Part 1: Input/Output Logical Specification Rev1.3 (Non-Patent Literature 1)). Devices of the wireless base stations are now being put into practice corresponding to the specification of this Serial RapidIO

In Serial RapidIO, two types of transfer zones (number of lanes), and three transfer rates for one lane are prepared. The transfer data rate includes 1 Gbps, 2 Gbps, or 2.5 Gbps. The number of lanes is 1 lane or 4 lanes. By combining two types of lane numbers and three types of transfer rates for one lane, six types of transfer rates (transmission rate or reception rate) can be realized.

In Serial RapidIO, star type connection having a plurality of devices connected to a multiport switch is allowed. In the event of star type connection, data transfer is allowed even if the transmission rate of the source device and the reception rate of the destination device differ by virtue of buffering at the multiport switch.

### Citation List

### Non Patent Literature

NPL 1: RapidIO™ Interconnect Specification Part1: Input/Output Logical Specification Rev1.3, June 2005, Internet (URL: http://www.rapidio.org/zdata/specs/IO_logical.pdf)

### SUMMARY OF INVENTION

### Technical Problem

In a conventional star type connection transmission system, there may be the case where the data transmission rate is reduced in the event of transmitting data to a plurality of devices.

FIG. 8 is a diagram to describe a conventional transmission example.

As shown in FIG. 8 (a), a device 1 transmits data to a device 2 and a device 3. It is assumed that device 1, device 2, and device 3 have the transmission rate of 2 Gbps, 1 Gbps and 1 Gbps, respectively.

Device 1 first transmits data to device 2. After the transmission of data to device 2 ends, device 1 transmits data to device 3. Although data is transmitted to the multiport switch at 2 Gbps from device 1, data is output to device 2 or to device 3 from the multiport switch at 1 Gbps, since the reception rate of device 2 and device 3 is 1 Gbps. In other words, the transfer rate of only 1 Gbps can be realized in this transmission system even though the transmission rate of the source device is 2 Gbps.

In view of the foregoing, an object of the present invention is to provide a data transmission system, a data transmission method, and a data transmission device that can transmit data to a plurality of devices efficiently.

### Solution to Problem

To overcome the problem set forth above, the present invention is directed to a data transmission system including a multiport switch, and a plurality of devices connected to the multiport switch via a plurality of serial buses. A source device includes a transmission unit to select at least one destination device among the plurality of devices for transmitting data to the selected at least one destination device through the multiport switch and serial buses. The transmission unit includes a transmission ratio determination unit for determining, when a plurality of destination devices are selected, a ratio of data transmitted among the selected plurality of destination devices within one cycle based on a reception rate of the selected plurality of destination devices. The destination device includes a reception unit receiving data from a source device through the multiport switch and serial buses.

Preferably, the transmission ratio determination unit determines the ratio of data transmitted among the selected plurality of destination devices so as to be equal to the ratio of reception rate among the selected plurality of destination devices within 1 cycle.

Preferably, the length of a packet transmitted by the transmission unit is constant within at least one cycle. The transmission ratio determination unit determines the ratio of the number of packets transmitted among the selected plurality of destination devices so as to be equal to the ratio of reception rate among the selected plurality of destination devices within 1 cycle.

Preferably, communication through serial buses follows the Serial RapidIO specification.

The present invention is directed to a data transmission method at a data transmission system including in a multi port switch and a plurality of devices connected to the multiport switch via a plurality of serial buses. The method includes the steps of a source device selecting at least one destination device among the plurality of devices for transmitting data to the selected at least one destination device through the multiport switch and serial buses. The transmitting step includes the step of determining, when a plurality of destination devices are selected, a ratio of data transmitted among the selected plurality of destination devices within 1 cycle based on a reception rate of the selected plurality of destination devices. The data transmission method further includes the step of a destination device receiving data from a source device through the multiport switch and serial buses.

The present invention is directed to a data transmission device transmitting data to a plurality of devices through a multiport switch and serial buses. The data transmission device includes a transmission ratio determination unit determining a ratio of data transmitted among a plurality of devices within I cycle based on a reception rate of the plurality of devices, a generation unit generating a packet to be transmitted to the plurality of devices according to the determined ratio of data, and an output unit providing the generated packet onto the serial bus.

### Advantageous Effect of Invention

According to a data transmission system, a data transmission method, and a data transmission device of the present invention, data can be transmitted to a plurality of devices efficiently.

### BRIEF DESCRIPTION OF DRAWINGS

FIG. 1 represents a configuration of a data transmission system according to an embodiment of the present invention.

FIG. 2 represents a configuration of devices 1-4, and a multiport switch 7.

FIG. 3 is a flowchart representing an operation procedure of a transmission system according to an embodiment of the present invention.

FIG. 4 is a diagram to describe an exemplified transmission of the first embodiment.

FIG. 5 is a diagram to describe another exemplified transmission of the first embodiment.

FIG. 6 is a diagram to describe an exemplified transmission of a second embodiment.

FIG. 7 is a diagram to describe another exemplified transmission of the second embodiment.

FIG. 8 is a diagram to describe a conventional exemplified transmission of data.

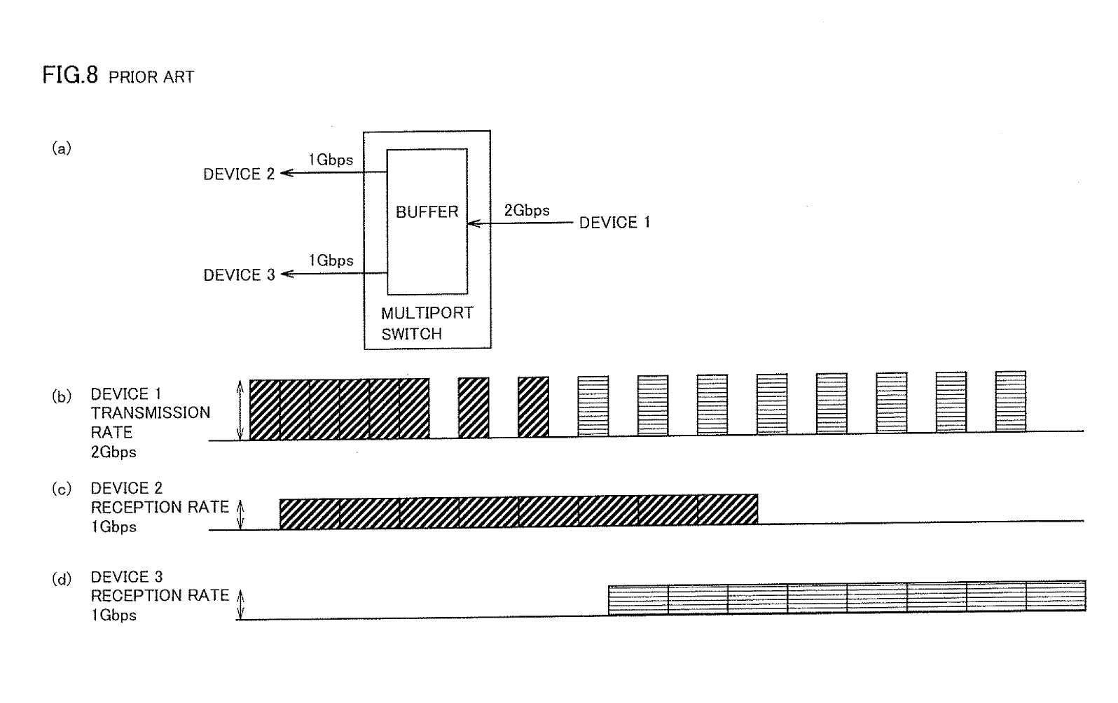

### DESCRIPTION OF EMBODIMENTS

Embodiments of the present invention will be described hereinafter with reference to the drawings.

### First Embodiment

(Data Transmission System Configuration)

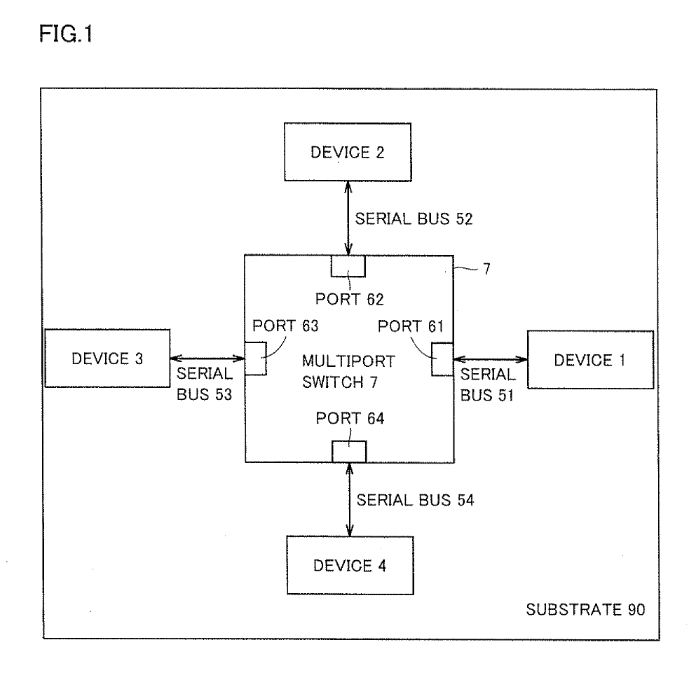

FIG. 1 represents a configuration of a data transmission system according to an embodiment of the present invention.

Referring to FIG. 1, the data transmission system has a plurality of devices 1-4 and a multiport switch 7 mounted on a substrate 90. Device 1 is connected to a port 61 of multiport switch 7 through a serial bus 51. Device 2 is connected to a port 62 of multiport switch 7 through a serial bus 52. Device 3 is connected to a port 63 of multiport switch 7 through a serial bus 53. Device 4 is connected to a port 64 of multiport switch 7 through a serial bus 54. The serial communication of the transmission system follows the Serial RapidIO specification.

(Configuration of Device and Multiport Switch)

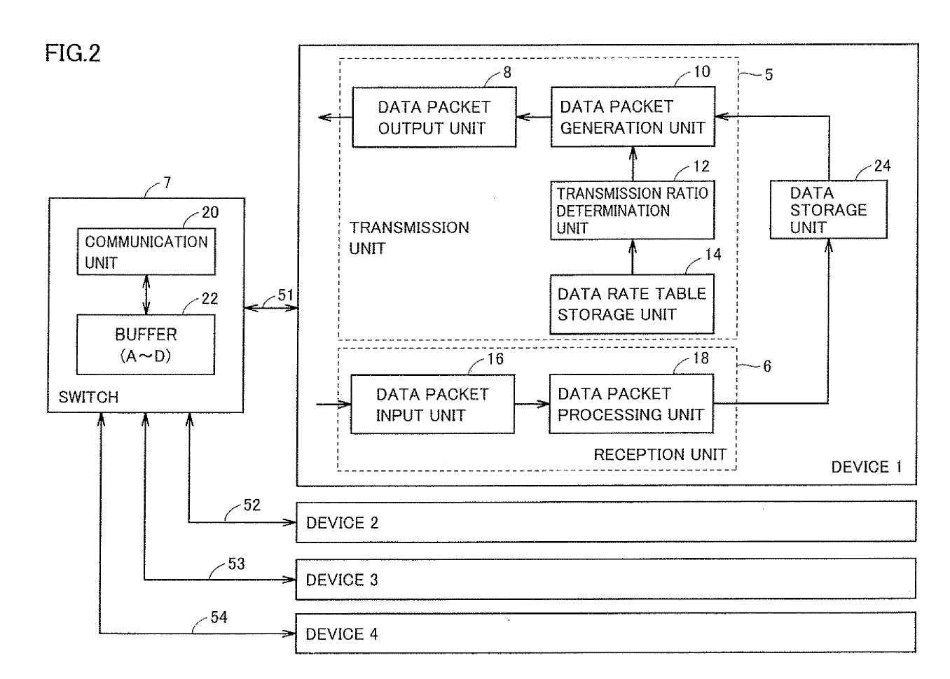

FIG. 2 represents a configuration of devices 1-4, and a multiport switch 7. Although the internal configuration of only device 1 is shown in FIG. 2, devices 2-4 have a configuration similar to that of device 1.

Device 1 includes a transmission unit 5, a reception unit 6, and a data storage unit 24. Data storage unit 24 stores data.

Transmission unit 5 includes a data rate table storage unit 14, a transmission ratio determination unit 12, a data packet generation unit 10, and a data packet output unit 8.

Data rate table storage unit 14 stores a data rate table defining the reception rate of other devices.

Transmission ratio determination unit 12 selects a destination device. In the case where a plurality of destination devices are selected, transmission ratio determination unit 12 refers to the data rate table to identify the transmission rates of the selected plurality of destination devices to determine at what ratio the data packet is to be transmitted to each device within 1 cycle based on the identified reception rates. Specifically, transmission ratio determination unit 12 determines the ratio such that the ratio of data transmitted among the selected plurality of destination devices within 1 cycle becomes equal to the ratio of reception rate among the selected plurality of destination devices.

Data packet generation unit 10 reads out data for a destination device from data storage unit 24 to generate a data packet including data read out in a pay load region. Data packet generation unit 10 alters the address ID of a data packet according to the transmission ratio determined at transmission ratio determination unit 12. It is assumed that the length of a data packet is constant within at least one cycle. The length of a data packet may be constant in all the cycles, may be altered for every one cycle, or may be altered in an arbitrary cycle.

Data packet output unit 8 outputs a data packet generated at data packet generation unit 10 onto serial bus 51.

Reception unit 6 includes a data packet input unit 1.6, and a data packet processing unit 18.

Data packet input unit 16 receives a data packet output from another device through multiport switch 7 and serial bus 51.

Data packet processing unit 18 processes the data packet received at data packet input unit 16 to write the data included in the pay load region of the data packet into data storage unit 24.

Multiport switch 7 includes a buffer 22, and a communication unit 20.

Communication unit 20 receives a data packet output from a source device for output to buffer 22. Communication unit 20 also outputs the data packet stored in buffer 22 to a destination device.

Buffer 22 stores a data packet output from a source device, and outputs the data packet when reception at a destination device is allowed. When the stored amount arrives at a full state, buffer 22 sends a signal to devices 1-4 connected to multiport switch 7 instructing that transmission is to be kept waiting.

(Operation)

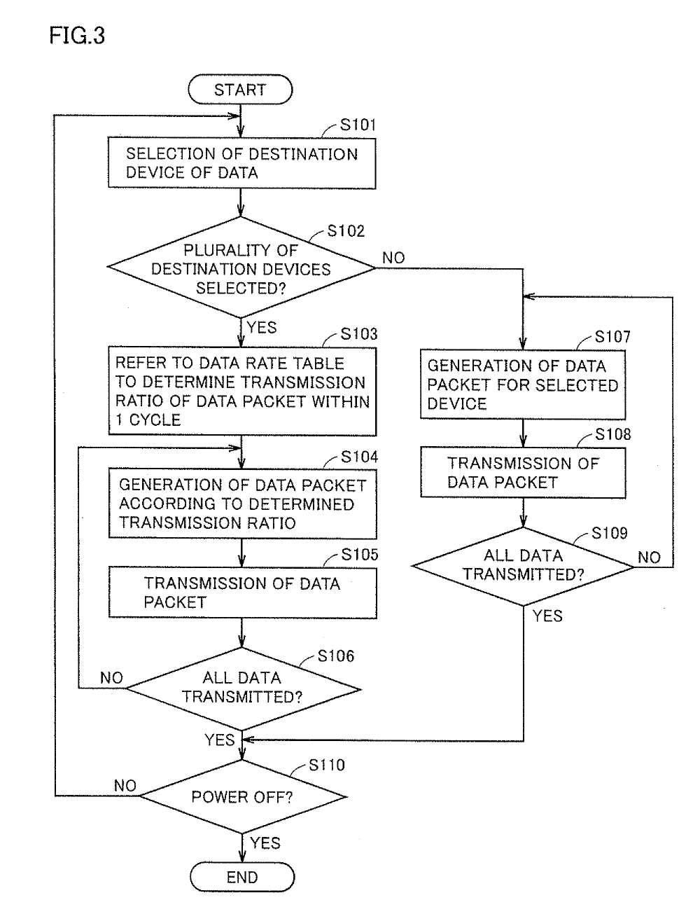

FIG. 3 is a flowchart representing an operation procedure of the transmission system according to an embodiment of the present invention.

First, transmission ratio determination unit 12 selects a device of the transmission destination of data (step S101).

When a plurality of destination devices are selected (YES at step S102), transmission ratio determination unit 12 determines at what ratio the data packet is to be transmitted to each device within 1 cycle, based on the reception rates of the selected plurality of destination devices in the data rate table (step S103).

Then, data packet generation unit 10 generates a data packet specifying a destination device based on the determined transmission ratio (step S104).

Data packet output unit 8 outputs the generated data packet (step S105).

The processes of steps S104 and S105 are repeated until transmission of all data ends (YES at step S106).

In the case where one destination device is selected (NO at step S102), data packet generation unit 10 generates a data packet specifying the selected destination device (step S107).

Then, data packet output unit 8 outputs the generated data packet (step S108).

The processes of steps 107 and S108 are repeated until transmission of all data ends (YES at step S109).

Until the power is turned off (YES at step S110), the process starting from step S101 is repeated.

(Exemplified Transmission 1)

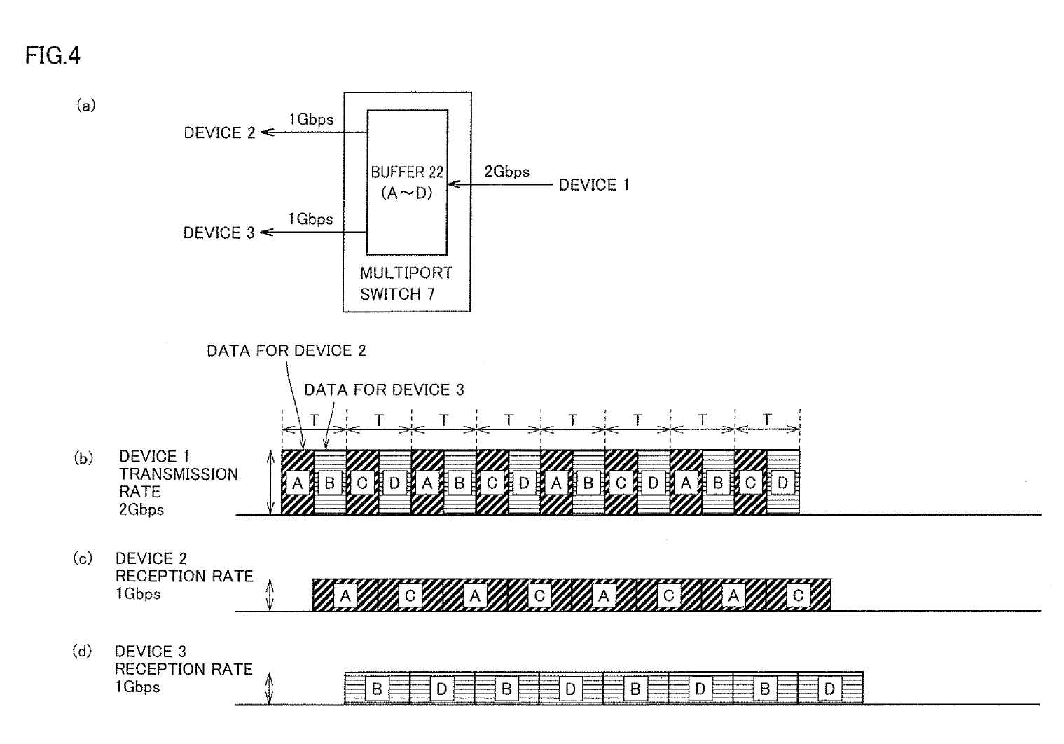

FIG. 4 is a diagram to describe an exemplified transmission of the first embodiment.

As shown in FIG. 4 (a), it is assumed that device 1 has selected devices 2 and 3 as the destination devices. It is assumed that device 1, device 2, and device 3 have a transmission rate of 2 Gbps, 1 Gbps, and 1 Gbps, respectively.

As shown in FIG. 4 (b), the data transmitted from device 1 is first stored in a region A of buffer 22 in multiport switch 7. Subsequently, the data is stored in the order of a region B, region C and region D. Thereafter, data is sequentially stored cyclically in this order. It is assumed that the size of region A, region B, region C and region D is N (bits), all identical to each other. It is also assumed that each data packet output from device 1 has the size of S (bits), identical to each other. Here, N is an integer multiple of S.

Transmission ratio determination unit 12 of device 1 determines the data packet transmission ratio such that the amount of data to device 2 (namely, the number of packets) and the amount of data to device 3 (namely, the number of packets) become 1:1, since the reception rate of device 2 is 1 Gbps and the reception rate of device 3 is 1 Gbps.

First, transmission unit 5 of device 1 outputs only a number of data packets for device 2 that can be stored in region A to multiport switch 7 at 2 Gbps, and then outputs only a number of data packets for device 3 that can be stored in region B to multiport switch 7 at 2 Gbps within 1 cycle. In other words, device 1 outputs only N/S data, packets for device 2 to multiport switch 7 at 2 Gbps, and then outputs only N/S data packets for device 3 to multiport switch 7 at 2 Gbps.

Next, transmission unit 5 of device 1 outputs only a number of data packets for device 2 that can be stored in region C to multiport switch 7 at 2 Gbps, and then outputs only a number of data packets for device 3 that can be stored in region D to multiport switch 7 at 2 Gbps within 1 cycle. In other words, device 1 outputs only N/S data packets for device 2 to multiport switch 7 at 2 Gbps, and then outputs only N/S data packets for device 3 to multiport switch 7 at 2 Gbps

Reception unit 6 of device 2 receives N/S data packets output at 1 Gbps from region A of buffer 22 in multiport switch 7, and then receives N/S data packets output at 1 Gbps from region C of buffer 22 in multiport switch 7.

Concurrently with the reception at device 2, reception unit 6 of device 3 receives N/S data packets output at 1 Gbps from region B of buffer 22 in multiport switch 7, and then receives N/S data packets output from region D of buffer 22 in multiport switch 7 at 1 Gbps.

In a similar manner thereafter, the process described above is repeated.

(Exemplified Transmission 2)

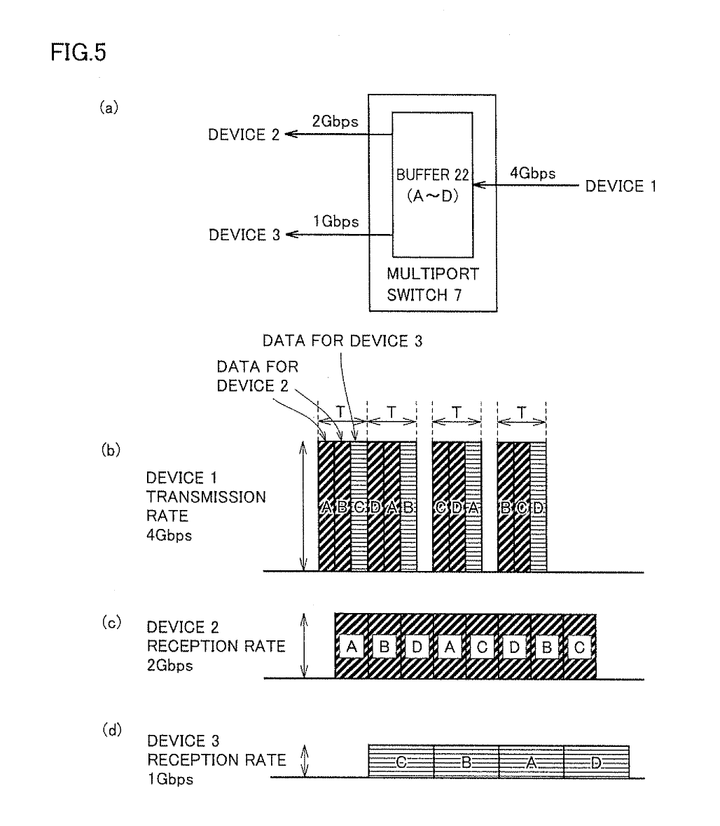

FIG. 5 is a diagram to describe another exemplified transmission of the first embodiment.

As shown in FIG. 5 (a), it is assumed that device 1 has selected device 2 and device 3 as the destination devices. It is assumed that device 1, device 2, and device 3 have a reception rate of 4 Gbps, 2 Gbps, and 1 Gbps, respectively.

As shown in FIG. 5 (b), the data transmitted from device 1 is first stored in region A of buffer 22 in multiport switch 7, and then stored in the order of region B, region C and region D. Thereafter, data is sequentially stored cyclically in this order. It is assumed that the size of region A, region B, region C and region D is N (bits), all identical to each other. It is also assumed that each data packet output from device 1 has the size of S (bits), identical to each other. Here, N is an integer multiple of S.

Transmission ratio determination unit 12 of device 1 determines the transmission ratio of data packets such that the amount of data for device 2 (namely, the number of packets) and the amount of data for device 3 (namely, the number of packets) within 1 cycle is 2:1 since the reception rate of device 2 is 2 Gbps and the reception rate of device 3 is 1 Gbps.

First, transmission unit 5 of device 1 outputs to multiport switch 7 only a number of data packets for device 2 that can be stored in regions A and B at 4 Gbps, and then outputs to multiport switch 7 only a number of data packets for device 3 that can be stored in region C at 4 Gbps within 1 cycle. Namely, device 1 outputs only 2×N/S data packets for device 2 to multiport switch 7 at 4 Gbps, and then outputs only N/S data packets for device 3 to multiport switch 7 at 4 Gbps.

Next, transmission unit 5 of device 1 outputs only a number of data packets for device 2 that can be stored in regions D and A to multiport switch 7 at 4 Gbps, and then outputs only a number of data packets for device 3 that can be stored in region B to multiport switch 7 at 4 Gbps within 1 cycle. Namely, device 1 outputs only 2×N/S data packets for device 2 to multiport switch 7 at 4 Gbps, and then outputs only N/S data packets for device 3 to multiport switch 7 at 4 Gbps.

Reception unit 6 of device 2 receives the N/S data packets output at 2 Gbps from region A of buffer 22 in multiport switch 7, then receives N/S data packets output at 2 Gbps from region B of buffer 22 in multiport switch 7, and then receives N/S data packets output at 2 Gbps from region D of buffer 22 in multiport switch 7.

Concurrently with the reception at device 2, reception unit 6 of device 3 receives N/S data packets output at 1 Gbps from region C of buffer 22 in multiport switch 7, then receives N/S data packets output at 1 Gbps from region B of buffer 22 in multiport switch 7, and then receives N/S data packets output at 1 Gbps from region A of buffer 22 in multiport switch 7.

Thereafter, the process set forth above is repeated in a similar manner.

Thus, according to the transmission system of an embodiment of the present invention, the time waiting for output of a data packet at a source device can be shortened to realize high transmission efficiency by determining the amount of data transmission for each device 2 within 1 cycle (namely, the number of transmission packets) based on the reception rates of the plurality of destination devices.

### Second Embodiment

The second embodiment of the present invention relates to a transmission system having a transmission ratio similar to that of the first embodiment, further characterized in that one cycle T is shorter than that of the first embodiment.

Transmission ratio determination unit 12 of the second embodiment determines the ratio, when a plurality of destination devices are selected, such that the ratio of the number of packets transmitted among the selected plurality of destination devices becomes equal to the ratio of reception rate among the selected plurality of destination devices.

(Exemplified Transmission 1)

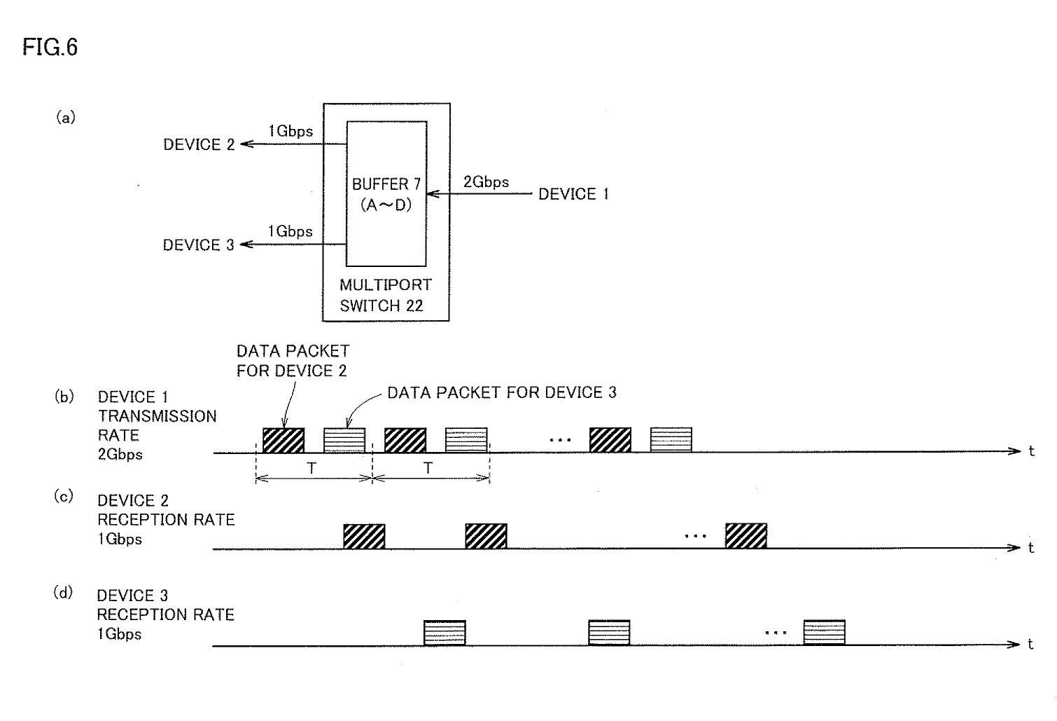

FIG. 6 is a diagram to describe an exemplified transmission of the second embodiment.

As shown in FIG. 6 (a), it is assumed that device 1 has selected device 2 and device 3 as the destination devices. It is also assumed that device 1, device 2, and device 3 have a transmission rate of 2 Gbps, 1 Gbps and 1 Gbps, respectively.

As shown in FIG. 6 (b), the data packet transmitted from device 1 is first stored at buffer 22 in multiport switch 7. It is assumed that all data packets output from device 1 have the same size.

Transmission ratio determination unit 12 of device 1 determines the transmission ratio of data packets such that one data packet for device 2 and one data packet for device 3 are included within 1 cycle T since the reception rate of device 2 is 1 Gbps and the reception rate of device 3 is 1 Gbps.

First, transmission unit 5 of device 1 outputs one data packet for device 2 to multiport switch 7 at 2 Gbps, and then outputs one data packet for device 3 to multiport 20. switch 7 at 2 Gbps within 1 cycle T.

Reception unit 6 of device 2 receives the data packet output from multiport switch 7 at 1 Gbps.

Concurrently with the reception at device 2, reception unit 6 of device 3 receives the data packet output from multiport switch 7 at 1 Gbps.

Hereinafter, the process set forth above is repeated in a similar manner.

(Exemplified Transmission 2)

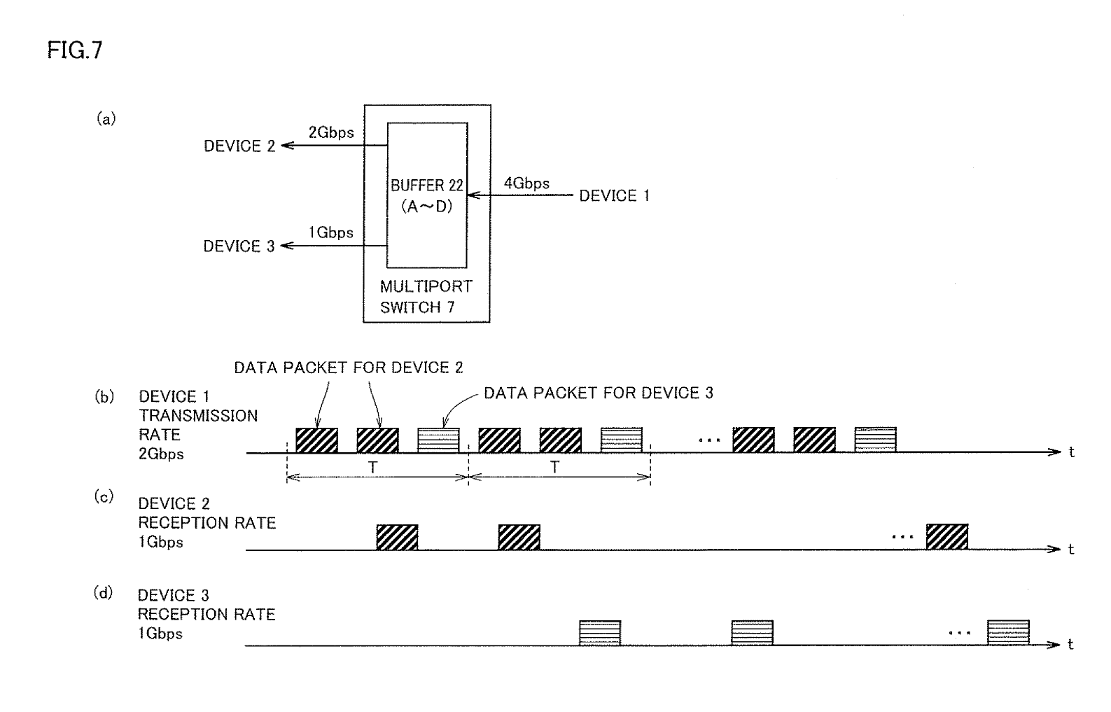

FIG. 7 is a diagram to describe another exemplified transmission of the second embodiment.

As shown in FIG. 7 (a), it is assumed that device 1 has selected device 2 and device 3 as the destination devices. It is assumed that device 1, device 2, and device 3 have a transmission rate of 4 Gbps, 2 Gbps, and 1 Gbps, respectively.

As shown in FIG. 7 (b), the data packet transmitted from device 1 is first stored at buffer 22 in multiport switch 7. It is assumed that all data packets output from device 1 have the same size.

Transmission ratio determination unit 12 of device 1 determines the data packet transmission ratio such that two data packets for device 2 and one data packet for device 3 are included within 1 cycle T since the reception rate of device 2 is 2 Gbps and the reception rate of device 3 is 1 Gbps.

First, transmission unit 5 of device 1 outputs two data packets for device 2 to multiport switch 7 at 4 Gbps, and then outputs one data packet for device 3 to multiport switch 7 at 4 Gbps, within 1 cycle T.

Reception unit 6 of device 2 receives the data packet output from multiport switch 7 at 2 Gbps.

Concurrently with the reception at device 2, reception unit 6 of device 3 receives the data packet output from multiport switch 7 at 1 Gbps.

Hereinafter, the process set forth above is repeated in a similar manner.

According to the transmission system of the present embodiment in the present invention, the time of the source device kept waiting for the output of a data packet can be shortened to realize high transmission efficiency by determining the amount of data to be transmitted to each device 2 (that is, the number of transmission packets) within 1 cycle T based on the reception rates of the plurality of destination devices, likewise with the first embodiment.

(Modification)

The present invention is not limited to the above-described embodiments, and may include the modification set forth below.

(1) Packet Transmission Ratio of Second Embodiment

When the reception rate of n destination devices is a1, a2, . . . , an in the second embodiment, the number of transmission packets for each device within 1 cycle will be b1, b2, . . . , bn (=k×a1, k×a2, . . . ,k×an), where k is the smallest number for bi (i=1 to n) to be an integer. For example, when the reception rate of three destination devices is 2 Gbps, 4 Gbps and 8 Gbps, respectively, k=½ is established. The number of transmission packets for the three devices within 1 cycle will be 1, 2 and 4. When the reception rate of the three destination devices is 1 Gbps, 2 Gbps, and 2.5 Gbps, k=2 is established. The number of transmission packets for the three devices within 1 cycle will be 2, 4 and 5.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

1-4 device; 5 transmission unit; 6 reception unit; 7 multiport switch; 8 data packet output unit; 10 data packet generation unit; 12 transmission ratio determination unit; 14 data table storage unit; 16 data packet input unit; 18 data packet processing unit; 20 communication unit; 22 buffer; 24 data storage unit; 52-54 serial bus; 62-64 port; 90 substrate.

1. A data transmission system including a multiport switch, and a plurality of devices connected to said multiport switch via a plurality of serial buses,
a source device including
a transmission unit selecting at least one destination device among said plurality of devices for transmitting data to the selected at least one destination device through said multiport switch and said serial buses, said transmission unit including a transmission ratio determination unit for determining, when a plurality of destination devices are selected, a ratio of data transmitted among said selected plurality of destination devices within 1 cycle based on a reception rate of said selected plurality of destination devices,
a destination device including
a reception unit receiving data from a source device through said multiport switch and serial buses.

2. The data transmission system according to claim 1, wherein said transmission ratio determination unit determines the ratio of data transmitted among said selected plurality of destination devices so as to be equal to the ratio of reception rate among said selected plurality of destination devices within 1 cycle.

3. The data transmission system according to claim 1, wherein a length of a packet transmitted by said transmission unit is constant at least within 1 cycle,
said transmission ratio determination unit determines a ratio of the number of packets transmitted among said selected plurality of destination devices so as to be equal to the ratio of reception rate among said selected plurality of destination devices within 1 cycle.

4. The data transmission system according to claim 1, wherein communication through said serial buses follows a Serial RapidIO specification.

5. A data transmission method at a data transmission system including a multiport switch and a plurality of devices connected to said multiport switch via a plurality of serial buses, said data transmission method comprising the steps of:
a source device selecting at least one destination device among said plurality of devices for transmitting data to the selected at least one destination device through said multiport switch and said serial buses, said transmitting step including the step of determining, when a plurality of destination devices are selected, a ratio of data transmitted among said selected plurality of destination devices within 1 cycle based on a reception rate of said selected plurality of destination devices, and
a destination device receiving data from a source device through said multiport switch and serial buses.

6. A data transmission device transmitting data to a plurality of devices through a multiport switch and serial buses, said data transmission device comprising:
a transmission ratio determination unit determining a ratio of data transmitted among said plurality of devices within 1 cycle, based on a reception rate of said plurality of devices,
a generation unit generating a packet to be transmitted to said plurality of devices according to said determined ratio of data, and
an output unit providing said generated packet onto said serial bus.
